(19) United States
(12) Patent Application Publication
(10) Pub. No.: US 2026/0188842 A1
(43) Pub. Date: Jul. 2, 2026

(54) LITHIUM ION CONDUCTOR, LITHIUM BATTERY INCLUDING LITHIUM ION CONDUCTOR, AND METHOD OF PREPARING LITHIUM ION CONDUCTOR

(71) Applicant: Samsung Electronics Co., Ltd., Suwon-si (KR)

(72) Inventors: Hyeokjo Gwon, Suwon-si (KR); Giyun Kwon, Suwon-si (KR); Gabin Yoon, Suwon-si (KR); Hwiyeol Park, Suwon-si (KR)

(21) Appl. No.: 19/428,458

(22) Filed: Dec. 22, 2025

(30) Foreign Application Priority Data
Dec. 27, 2024 (KR) 10-2024-0199338

(51) Int. Cl. H01M 50/434; H01M 10/0525; H01M 50/403; H01M 50/449; H01M 50/497

(52) U.S. Cl. CPC H01M 50/434; H01M 10/0525; H01M 50/403; H01M 50/449; H01M 50/497

(57) ABSTRACT

A lithium ion conductor including a first compound represented by Formula 1.

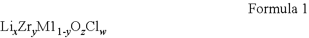

In Formula 1, M1 includes one or more elements belonging to groups 3 to 15 of the periodic table, and 1≤x≤3, 0.2<y<1, 0.5≤z≤1.5, 3.5≤w≤4.5 and 4.5≤z+w≤5.5. The first compound includes a crystalline phase belonging to the P-3m1 space group of a trigonal crystal system. A lithium battery including the lithium ion conductor, and a method of preparing the lithium ion conductor.

### CROSS-REFERENCE TO RELATED APPLICATION

This application is based on and claims priority to Korean Patent Application No. 10-2024-0199338, filed on Dec. 27, 2024, in the Korean Intellectual Property Office, and all the benefits accruing therefrom under 35 USC § 119, the disclosure of which is incorporated by reference herein in its entirety.

### BACKGROUND

### 1. Field

The disclosure relates to a lithium ion conductor, a lithium battery including the lithium ion conductor, and a method of preparing the lithium ion conductor.

### 2. Description of the Related Art

Lithium batteries mainly use liquid electrolytes containing flammable organic solvents, which pose a risk of overheating and fire in the event of a short circuit. Considering this, lithium batteries using solid electrolytes instead of liquid electrolytes have been proposed.

Sulfide-based solid electrolytes may form an interface in close contact with electrode active materials due to their ductility. Sulfide-based solid electrolytes may emit hazardous gases and have low electrochemical stability.

Oxide-based solid electrolytes are stable in the atmosphere, are easy to handle, and may have high electrochemical stability. Oxide-based solid electrolytes have brittleness, making it difficult to form an interface in close contact with electrode active materials. Oxyhalide-based solid electrolytes, which are distinct from sulfide-based solid electrolytes and oxide-based solid electrolytes, are being studied.

### SUMMARY

Oxyhalide-based solid electrolytes have similar ductility to sulfide-based solid electrolytes, but are more stable in air, easier to handle, and have improved electrochemical stability compared to sulfide-based solid electrolytes. An oxyhalide solid electrolyte that is electrochemically stable, stable in air, and provides excellent ionic conductivity is required.

Provided is a lithium ion conductor providing excellent ionic conductivity.

Provided is a lithium battery including the lithium ion conductor.

Provided is a method of preparing the lithium ion conductor.

Additional aspects will be set forth in part in the description which follows and, in part, will be apparent from the description, or may be learned by practice of the presented embodiments of the disclosure.

According to an aspect of the disclosure,
a lithium ion conductor includes a first compound represented by Formula 1,
wherein the first compound includes a crystalline phase belonging to the P-3m1 space group of a trigonal crystal system:

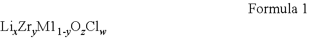

wherein in Formula 1,
M1 includes one or more elements belonging to groups 3 to 15 of the periodic table, and
1≤x≤3, 0.2<y<1, 0.5≤z≤1.5, 3.5≤w≤4.5 and 4.5≤z+w≤5.5.

According to another aspect of the disclosure,
a lithium ion conductor may include a first compound represented by Formula 1,
wherein the first compound may include a crystalline phase belonging to a trigonal crystal system, a crystalline phase belonging to an orthorhombic crystal system, a crystalline phase belonging to a hexagonal crystal system, or a combination thereof:

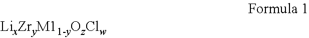

wherein in Formula 1,
M1 may include one or more elements belonging to groups 3 to 15 of the periodic table, and
1≤x≤3, 0.2<y<1, 0.5≤z≤1.5, 3.5≤w≤4.5 and 4.5≤z+w≤5.5.

According to another aspect of the disclosure,
a lithium battery includes a cathode, an anode, and
a solid electrolyte layer disposed between the cathode and the anode,
wherein at least one of the cathode, the anode, and the solid electrolyte layer includes the lithium ion conductor.

According to another aspect of the disclosure,
a method of preparing a lithium ion conductor includes mixing a lithium precursor, a zirconium precursor, a dopant M1 precursor and a chlorine precursor to prepare a mixture, and
mechanically milling the mixture to prepare a lithium ion conductor, wherein the lithium ion conductor includes a first compound represented by Formula 1, and
wherein the first compound includes a crystalline phase belonging to the P-3m1 space group of a trigonal crystal system:

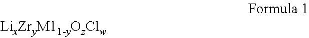

wherein in Formula 1,
M1 includes one or more elements belonging to groups 3 to 15 of the periodic table, and
1≤x≤3, 0.2<y<1, 0.5≤z≤1.5, 3.5≤w≤4.5 and 4.5≤z+w≤5.5.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a graph showing intensity (arbitrary unit, a.u.) versus diffraction angle (degree, 2θ) of the results of X-ray diffraction analysis of lithium ion conductors prepared in Examples 1 to 3 and Comparative Examples 1 to 2;

FIG. 2 is a graph showing intensity (arbitrary unit, a.u.) versus diffraction angle (degree, 2θ) of the results of X-ray diffraction analysis of lithium ion conductors prepared in Comparative Example 2 and Reference Example 1;

FIG. 3 is a Nyquist plot showing imaginary part of impedance, Z″ (ohms, Ω) versus real part of impedance, Z′ (ohms, Ω) of the results of impedance measurements according to temperature of a symmetrical cell including a lithium ion conductor prepared in Example 1;

FIG. 4 is a Nyquist plot showing imaginary part of impedance, Z″ (ohms, Ω) versus real part of impedance, Z′ (ohms, Ω) of the results of impedance measurements according to temperature of a symmetrical cell including a lithium ion conductor prepared in Example 3;

FIG. 5 is a Nyquist plot showing imaginary part of impedance, Z″ (ohms, Ω) versus real part of impedance, Z′ (ohms, Ω) of the results of impedance measurement according to temperature of a symmetrical cell including a lithium ion conductor prepared in Comparative Example 2;

FIG. 6 is an Arrhenius plot showing the logarithm of conductivity (Siemens per centimeters) versus temperature, 1000/T (inverse kelvin, 1/K) of the ion conductivity of lithium ion conductors prepared in Example 1, Example 3, and Comparative Example 2 as a function of temperature;

FIG. 7 is a cross-sectional view schematically showing the structure of a lithium battery according to an embodiment;

FIG. 8 is a cross-sectional view schematically showing the structure of a lithium battery according to an embodiment;

FIG. 9 is a cross-sectional view schematically showing the structure of a lithium battery according to an embodiment;

FIG. 10 is a perspective view schematically showing the structure of a lithium battery according to an embodiment; and

FIG. 11 is a cross-sectional view schematically showing the structure of a lithium battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Various embodiments have been illustrated in the attached drawings. However, the inventive concept may be embodied in many other forms, and should not be construed as limited to the embodiments described herein. Rather, these embodiments are provided so that the disclosure may be thorough and complete and to fully convey the scope of the inventive concept to those skilled in the art.

Embodiments are described in the disclosure with reference to cross-sectional views of idealized embodiments. For example, variations from the shape of the drawing may be expected as a result of manufacturing techniques and/or tolerances. Therefore, the embodiments described in the disclosure should not be construed as being limited to the specific shapes of regions as depicted in the drawings of the disclosure, but should include, for example, deviations in shapes resulting from manufacturing. For example, regions illustrated or described as being flat may be rough and/or include nonlinear features. Also, the sharply illustrated angles may be rounded. Accordingly, the regions depicted in the drawings are inherently schematic, and their shapes are not intended to depict the precise shape of the regions or to limit the scope of the disclosure. In the disclosure, the same reference numerals refer to the same components.

Terms such as “first,” “second,” and “third” may be used herein to describe various components, ingredients, regions, layers, and/or zones, but are not limited by these terms. These terms are used only to distinguish one component, ingredient, region, layer or zone from another component, ingredient, region, layer, or zone. Accordingly, a first component, ingredient, region, layer, or zone described below may be referred to as a second component, ingredient, region, layer, or zone without departing from the teachings of this disclosure.

Spatially relative terms such as “beneath,” “below,” “lower,” “above,” “upper,” etc. may be used herein for ease of description to describe one element or feature's relationship to another element or feature. It will be understood that spatially relative terms are intended to encompass different orientations of the device in use or operation in addition to the orientation depicted in the drawings. For example, if the device in the drawings is turned over, elements described as “beneath” or “below” other elements or features would then be oriented “above” the other elements or features. Accordingly, the exemplary term “below” may encompass both an orientation of above and below. The device may be otherwise oriented (rotated 90 degrees or at other orientations) and the spatially relative terms used herein may be interpreted accordingly. It may be understood that when an element is referred to as being “on” another element, it may be directly on top of the other element, or there may be other elements intervening between them. In contrast, when an element is said to be “directly on” another element, there are no intervening elements between them.

As used herein, the singular forms “a,” “an,” and “the” are intended to include the plural forms, including “at least one,” unless the context clearly dictates otherwise. The wording “at least one” should not be construed as limited to being singular. As used herein, the term “and/or” includes any and all combinations of one or more of the listed items. When used in the detailed description, the terms “includes” and/or “including” specify the presence of the stated features, regions, integers, steps, operations, elements, components, and/or ingredients, but do not preclude the presence or addition of one or more other features, regions, integers, steps, operations, elements, components and/or groups thereof.

Unless otherwise defined, all terms (including technical and scientific terms) as used herein have the same meaning as commonly understood by one of ordinary skill in the art to which this disclosure belongs. Additionally, terms defined in commonly used dictionaries should be interpreted as having a meaning consistent with their meaning within the context of the relevant art and the disclosure, and not in an idealized or overly formal sense.

As used herein, “group” means a group of the Periodic Table of the Elements according to the International Union of Pure and Applied Chemistry (“IUPAC”) Group 1-18 classification system.

As used herein, the “particle diameter” indicates an average diameter of the particle when the particle is spherical, and indicates an average major axis length of the particle when the particle is non-spherical. The particle diameter of the particles may be measured using a particle size analyzer (PSA). The “particle diameter” is, for example, an average particle diameter. The “average particle diameter” is, for example, the median particle diameter (D50).

As used herein, “D50” refers to the particle size corresponding to 50% cumulative volume, calculated from the smaller particle size side in the particle size distribution measured by laser diffraction.

As used herein, “D90” refers to the particle size corresponding to 90% cumulative volume, calculated from the smaller particle size side in the particle size distribution measured by laser diffraction.

As used herein, “D10” refers to the particle size corresponding to 10% cumulative volume, calculated from the smaller particle size side in the particle size distribution measured by laser diffraction.

As used herein, “lithium ion conductor” refers to a material having a lithium ion conductivity of 1×10⁻⁷ Siemens per centimeter (S/cm) or higher at room temperature and atmospheric pressure.

As used herein, “metal” includes both metals and metalloids such as silicon and germanium, in elemental or ionic states.

As used herein, “alloy” means a mixture of two or more metals.

As used herein, “electrode active material” refers to an electrode material capable of undergoing lithiation and delithiation.

As used herein, “cathode active material” refers to a cathode material capable of undergoing lithiation and delithiation.

As used herein, “anode active material” refers to an anode material capable of undergoing lithiation and delithiation.

As used herein, “lithiation” and “to lithiate” refers to a process of adding lithium to an electrode active material.

As used herein, “delithiation” and “to delithiate” refers to a process of removing lithium from an electrode active material.

As used herein, “charging” and “to charge” refers to a process of providing electrochemical energy to a battery.

As used herein, “discharging” and “to discharge” refers to a process of removing electrochemical energy from a battery.

As used herein, “positive electrode” and “cathode” refer to an electrode at which electrochemical reduction and lithiation occur during a discharge process.

As used herein, “negative electrode” and “anode” refer to an electrode at which electrochemical oxidation and delithiation occur during a discharge process.

Although specific embodiments have been described, alternatives, modifications, variations, improvements, and substantial equivalents that may not currently be anticipated or foreseeable could arise for the applicant or those skilled in the art. Therefore, the appended claims, as filed and as amended, are intended to encompass all such alternatives, modifications, variations, improvements, and substantial equivalents.

As used herein, the terms “free” or “free of” with respect to a specified component mean that the composition or material contains no more than a trace amount, typically less than 0.1% by weight, preferably less than 0.01% by weight, and more preferably undetectable by standard analytical methods known in the art.

When used in reference to a peak in a spectrum (e.g., X-ray diffraction (XRD)), “free of [the] peak” indicates that the peak associated with the referenced species or structural feature is absent, meaning it is not observable above the baseline noise using standard acquisition parameters.

When used in reference to phase (e.g., crystalline, amorphous, hydrate, polymorph), “free of [the] phase” means that the phase is not present in a detectable amount as determined by techniques such as powder X-ray diffraction (PXRD).

Hereinafter, a lithium ion conductor according to embodiments and a lithium battery including the same are described in more detail.

### Lithium Ion Conductor

A lithium ion conductor according to an embodiment includes a first compound represented by Formula 1. The first compound includes a crystalline phase belonging to the P-3m1 space group of the trigonal crystal system:

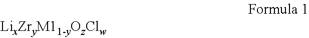

wherein in Formula 1,
M1 includes one or more elements belonging to groups 3 to 15 of the periodic table, and
1≤x≤3, 0.2<y<1, 0.5≤z≤1.5, 3.5≤w≤4.5 and 4.5≤z+w≤5.5.

In Formula 1, for example, it may be that 1≤x≤2.5, 1≤x≤2, or 1≤x≤1.5. In Formula 1, for example, it may be 0.2<y≤0.9, 0.2<y≤0.8 or 0.2<y≤0.6. In Formula 1, for example, it may be 0.7≤z≤1.3 or 0.8≤z≤1.2. In Formula 1, for example, it may be 3.6≤w≤4.4 or 3.7≤w≤4.3. In Formula 1, for example, it may be 4.6≤z+w≤5.4 or 4.7≤z+w≤5.3.

The first compound may be a crystalline compound. The first compound may be, for example, a compound having one or more crystalline peaks in an XRD spectrum. Crystalline compounds are distinguished from amorphous compounds, which do not exhibit crystalline peaks in the XRD spectrum.

The first compound may contain a crystal phase belonging to the trigonal crystal system. A lithium ion conductor including a first compound is distinguished in terms of its basic crystal structure from a lithium ion conductor that includes, for example, a crystal phase belonging to a monoclinic crystal system or a crystal phase belonging to a cubic crystal system.

The first compound may include a crystal phase belonging to the P-3m1 space group of the trigonal system. By including a crystal phase belonging to the P-3m1 space group of the trigonal crystal system, the first compound is distinguished from lithium ion conductors including crystal phases belonging to other crystal systems in terms of the symmetry of the spatially arranged crystal structure.

The first compound may include zirconium. By including zirconium in the first compound, the atmospheric stability and/or electrochemical stability of a lithium ion conductor including the first compound may be improved.

The first compound may include dopant M1. By including the dopant M1, the first compound may provide improved ionic conductivity.

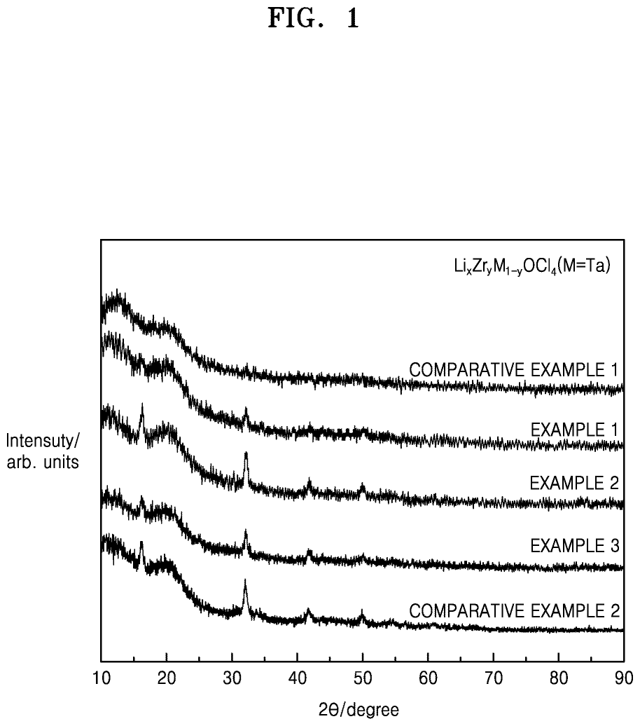

The first compound may have crystallinity by including dopant M1 in an amount exceeding 0.2 mole based on 1 mole of the first compound. Referring to FIG. 1, a compound having a content of dopant M1 of 0.2 mole or less is, for example, an amorphous compound that does not have a crystalline phase. A lithium ion conductor including a first compound, which is a crystalline compound, may have relatively improved moisture stability compared to, for example, a lithium ion conductor including an amorphous compound.

The first compound may be an oxyhalide compound including chlorine and oxygen. A solid ion conductor including the first compound may be easily pressurized, sintered, and/or molded without heat treatment due to its ductility. The first compound may be easily manufactured and handled because it has a low possibility of generating hazardous gases containing sulfur.

The first compound may be represented by Formula 1, wherein M1 may include, for example, Ta, Nb, Hf, Sn, Al, In, Sb, Sc, Y, La, Ce, Pr, Nd, Pm, Sm, Eu, Gd, Tb, Dv, Ho, Er, Tm, Yb, Lu or a combination thereof. By including these metals, M1 may provide improved ionic conductivity to the lithium ion conductor.

The first compound may be represented, for example, by Formula 2:

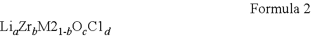

wherein in Formula 1,
M2 may include Ta, Nb, Hf, Sn, Sc, Y, Al, In, Sb or a combination thereof, and
1≤a≤3, 0.2<b<1, 0.8≤c≤1.2, 3.7≤d≤4.3 and 4.5≤c+d≤5.5.

In Formula 2, it may be, for example, 1≤a≤2.5, 1≤a≤2 or 1≤a≤1.5. In Formula 2, it may be, for example, 0.2<b≤0.9, 0.2<b≤0.8 or 0.2<b≤0. In Formula 2, it may be, for example, 0.7≤c≤1.3 or 0.8≤c≤1.2. In Formula 2, for example, it may be 3.8≤d≤4.2 or 3.9≤d≤4.1. In Formula 2, for example, it may be 4.6≤c+d≤5.4 or 4.7≤c+d≤5.3.

The first compound represented by Formula 2 may provide improved ionic conductivity.

The first compound may be represented, for example, by Formula 3:

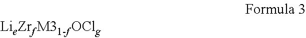

wherein in Formula 3,
M3 may include Ta, Nb, Hf, Sn, Sc, Y, Al, In, Sb or a combination thereof, and
1≤e≤3, 0.2<f<1 and 3.7≤g≤4.3.

In Formula 3, it may be, for example, 1≤e≤2.5, 1≤e≤2, or 1≤e≤1.5. In Formula 3, it may be, for example, 0.2<f≤0.9, 0.2<f≤0.8 or 0.2<f≤0.6. In Formula 3, it may be, for example, 3.8≤g≤4.2 or 3.9≤g≤4.1.

The first compound represented by Formula 3 may provide improved ionic conductivity.

The first compound may be represented, for example, by Formulae 4A to 4I:

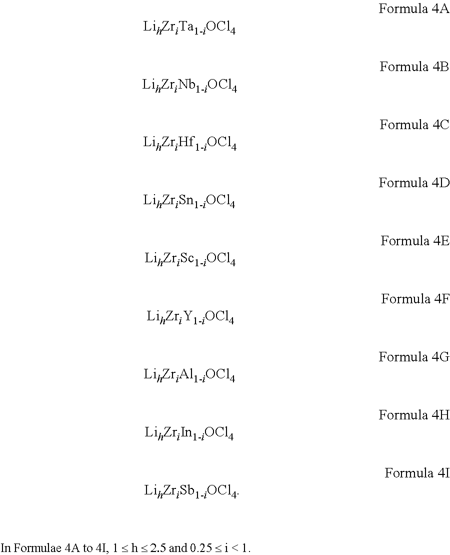

In Formulae 4A to 4I, it may be, for example, 1≤h≤2 or 1≤h≤1.5. In Formulae 4A to 4I, it may be, for example, 0.25≤i≤0.9, 0.25≤i≤0.8 or 0.25≤i≤0.6.

The first compound represented by Formulae 4A to 4I may provide improved ionic conductivity.

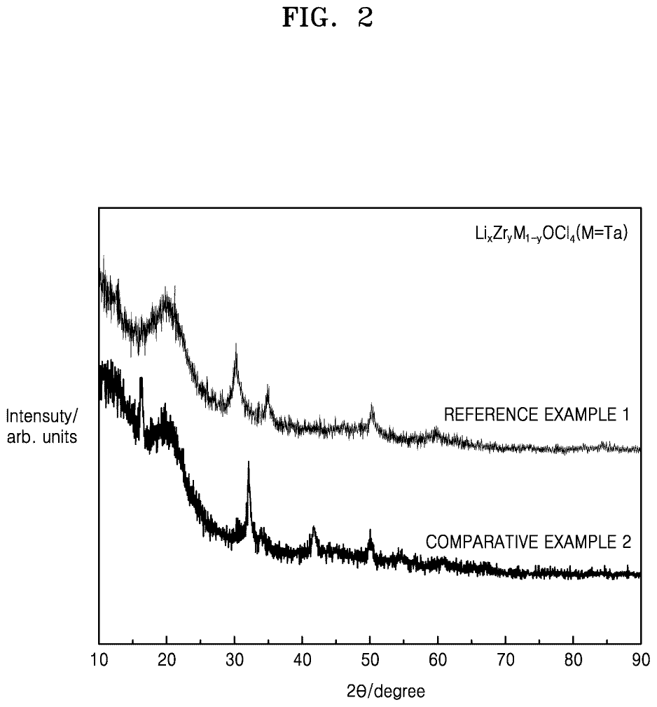

Referring to FIGS. 1 and 2, a lithium ion conductor including a first compound may have, for example, a first peak at a diffraction angle of 16.0±1.0°2θ and a second peak at a diffraction angle of 32.0±1.0°2θ in an XRD spectrum. The ratio (Ia/Ib) of the intensity of the first peak (Ia) to the intensity of the second peak (Ib), i.e., the peak intensity ratio (Ia/Ib), may be, for example, 3 or less, 2 or less, or 1 or less. The ratio (Ia/Ib) of the intensity of the first peak (Ia) to the intensity of the second peak (Ib), i.e., the peak intensity ratio (Ia/Ib), may be, for example, about 0.01 to about 3, about 0.1 to about 2 or about 0.1 to about 1. Lithium ion conductors may have improved ionic conductivity by having a peak intensity ratio (Ia/Ic) in this range.

The ionic conductivity of the lithium ion conductor including the first compound may be, for example, 0.1 milliSiemens per centimeter (mS/cm) or more, 0.2 mS/cm or more, or 0.3 mS/cm or more at 25° C. and 1 atmosphere (atm). The ionic conductivity of the lithium ion conductor may be, for example, about 0.1 mS/cm to about 50 mS/cm, about 0.2 mS/cm to about 10 mS/cm, or about 0.3 mS/cm to about 5 mS/cm at 25° C. and 1 atm. By having an ionic conductivity within this range, the lithium ion conductor may improve the charge and discharge characteristics of a lithium battery containing the lithium ion conductor. The ionic conductivity of a lithium ion conductor may be measured, for example, by impedance analysis.

The activation energy (Eₐ) of the lithium ion conductor including the first compound may be, for example, 300 millielectronvolts (meV) or less, 290 meV or less, or 280 meV or less at 25° C. and 1 atm. The activation energy (Eₐ) of a lithium ion conductor may be, for example, about 100 meV to about 300 meV, about 200 meV to about 290 meV or about 250 meV to about 280 meV at 25° C. and 1 atm. By having an activation energy within this range, the lithium ion conductor may improve the charge and discharge characteristics of the lithium battery containing the lithium ion conductor. The activation energy of a lithium ion conductor may be measured, for example, by temperature-dependent impedance analysis.

The first compound may include, for example, a crystalline phase belonging to the P-3m1 space group of a trigonal crystal system, a crystalline phase belonging to the Pnma space group of an orthorhombic crystal system, a crystalline phase belonging to the P63mc space group of a hexagonal crystal system, or a combination thereof. By including one or more of these crystal phases, the first compound may improve the ionic conductivity of the lithium ion conductor. The first compound may include, for example, a crystalline phase belonging to the Pnma space group of the orthorhombic crystal system. The first compound may include, for example, a crystalline phase belonging to the P63mc space group of the hexagonal crystal system. The first compound may include, for example, both a crystalline phase belonging to the P-3m1 space group of a trigonal crystal system and a crystalline phase belonging to the Pnma space group of an orthorhombic crystal system. The first compound may include, for example, both a crystalline phase belonging to the P-3m1 space group of a trigonal crystal system and a crystalline phase belonging to the P63mc space group of a hexagonal crystal system. The first compound may include, for example, a crystalline phase belonging to the P-3m1 space group of a trigonal crystal system, a crystalline phase belonging to the Pnma space group of an orthorhombic crystal system, and a crystalline phase belonging to the P63mc space group of a hexagonal crystal system.

The lithium ion conductor may further include a second compound in addition to the first compound. The second compound may be, for example, a compound including an amorphous phase. The second compound may be, for example, an impurity. The lithium ion conductor may not include a second compound. The lithium ion conductor may contain a trace amount of a second compound. The content of the second compound may be, for example, 3 weight percent (wt %) or less, 2 wt % or less, 1 wt % or less, 0.5 wt % or less, or 0.1 wt % or less based on the total weight of the first compound and the second compound. During the preparing process of a lithium ion conductor, a second compound having a low dopant content, for example, may be included as an impurity. The second compound may include, for example, lithium, zirconium, a first metal belonging to groups 3 to 15 of the periodic table, oxygen, and chlorine. For example, the second compound may contain about 1 mole to about 3 moles of lithium, more than about 0 mole and less than about 0.2 moles of zirconium, more than about 0.2 mole and less than about 1 mole of the first metal, about 0.5 mole to about 1.5 moles of oxygen, and about 3.5 mole to about 4.5 moles of chlorine, based on 1 mole of the second compound.

The second compound may be represented, for example, by Formula 5:

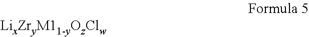

wherein in Formula 5,
M1 may include one or more elements belonging to groups 3 to 15 of the periodic table, and
1≤x≤3, 0<y<0.2, 0.5≤z≤1.5, 3.5≤w≤4.5 and 4.5≤z+w≤5.5.

In Formula 5, for example, 0<y≤0.15, 0<y≤0.10 or 0<y≤0.05.

The lithium ion conductor may include a first compound, and the first compound may include, for example, about 1.0 mole to less than about 1.7 mole of lithium or about 1.0 mole to about 1.5 mole of lithium based on 1 mole of the first compound.

The lithium ion conductor may include a first compound, where the molar ratio of oxygen to dopant M1 (O/M1) in the first compound may be 1 or more, 1.2 or more, or 1.4 or more. For example, in the first compound represented by Formula 1, the molar ratio of oxygen to dopant M1 (O/M1) may be 1 or more, 1.2 or more, or 1.4 or more.

In lithium ion conductors, for example, a crystalline phase belonging to the monoclinic crystal system may be free.

In lithium ion conductors, for example, a crystalline phase belonging to the cubic crystal system may be free.

In the XRD spectrum of a lithium ion conductor, for example, the third peak at a diffraction angle of 21.5±1.5°2θ, the fourth peak at a diffraction angle of 30.0±0.5°2θ, and the fifth peak at a diffraction angle (2θ) of 35.0±0.5°2θ may be free.

### Lithium Battery

According to another embodiment, a lithium battery includes a cathode, an anode, and a solid electrolyte layer disposed between the cathode and the anode, where at least one of the cathode, the anode, and the solid electrolyte layer includes the lithium ion conductor described above. By including the aforementioned lithium ion conductor in a lithium battery, the internal resistance of the lithium battery may be reduced, the cycle characteristics of the lithium battery may be improved, and the atmospheric stability may be improved.

Lithium batteries may be used in electronic devices, and vehicles, etc., but they are also be used for other purposes. The lithium battery is not particularly limited and may be, for example, a lithium ion battery, a lithium air battery, an all solid battery, and the like. The lithium battery may be for example a secondary lithium battery such as an all solid secondary battery.

The all solid battery is not particularly limited and may include, for example, an all solid battery employing a non-precipitation type anode, an all solid battery employing a precipitation type anode, a multi-layered ceramic (MLC) all solid battery, and the like. A more detailed explanation of these batteries is provided below.

### Type 1: All Solid Battery Using Non-Precipitation Type Cathode

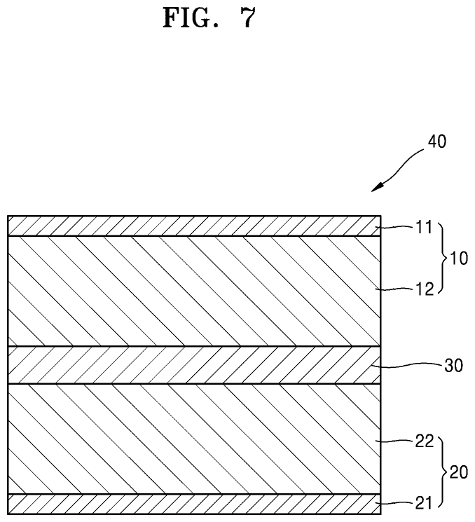

FIG. 7 is a schematic diagram of an all solid battery 40 including a non-precipitation type anode according to an embodiment. In an all solid battery 40 including a non-precipitation type anode, the initial charge capacity of the anode active material layer 22 during initial charge is, for example, more than 50%, 60% or more, 70% or more, 80% or more, 90% or more, or 100% or more of the initial charge capacity of the cathode active material layer 12.

The all solid battery 40 may be prepared as follows.

First, a cathode 10 is prepared. The cathode 10 may be prepared by forming a cathode active material layer 12 containing a cathode active material on a cathode current collector 11.

The cathode active material layer 12 may be prepared by a vapor-phase method or a solid-phase method. The vapor deposition method may be, but is not limited to, pulse laser deposition (PLD), sputtering deposition, chemical vapor deposition (CVD), or the like, and any method that may be used in the relevant technical field may be used. The solid-phase method may be, but is not limited to, a sintering method, a sol-gel method, a doctor blade method, a screen printing method, a slurry casting method, a powder pressing method, or the like. Any method that may be used in the relevant technical field may be used.

The cathode active material layer 12 may be prepared, for example, as follows. A cathode active material composition is prepared by mixing a cathode active material, a conductive agent, a binder, and a solvent. The cathode 10 may be prepared by directly coating and drying the cathode active material composition on a cathode current collector 11, or the cathode active material composition may be cast on a separate support, and then the film obtained by peeling off the support may be laminated on a cathode current collector 11 to prepare the cathode 10. Alternatively, a cathode active material composition may be prepared in the form of electrode ink containing an excessive amount of solvent and printed onto the cathode current collector 11 using an inkjet or gravure printing method to prepare the cathode 10. The printing method is not limited to the aforementioned methods, and any method commonly used for coating and printing may be applied.

The cathode active material layer 12 includes a cathode active material.

Any cathode active material commonly used in lithium batteries may be used without limitation. The cathode active material may include, for example, a lithium transition metal oxide, a transition metal sulfide, or the like. The lithium transition metal oxide may include, for example, at least one composite oxide of lithium and a metal selected from cobalt, manganese, nickel, and a combination thereof. The cathode active material may be, for example, a compound represented by any one of the following Formulae: LiₐA_{1-b}B′_{b}D₂ (where 0.90≤a≤1, and 0≤b≤0.5); LiₐE_{1-b}B′_{b}O_{2-c}D_{c} (where 0.90≤a≤1, 0≤b≤0.5, 0≤c≤0.05); LiE_{2-b}B′_{b}O_{4-c}D_{c} (where 0≤b≤0.5, 0≤c≤0.05); LiₐNi_{1-b-c}Co_{b}B′_{c}D_{α} (where 0.90≤a≤1, 0≤b≤0.5, 0≤c≤0.05, 0<α≤2); LiₐNi_{1-b-c}Co_{b}B′_{c}O_{2-α}F′_{α} (where 0.90≤a≤1, 0≤b≤0.5, 0≤c≤0.05, 0<α<2); LiₐNi_{1-b-c}Mn_{b}B′_{c}D_{α} (where 0.90≤a≤1, 0≤b≤0.5, 0≤c≤0.05, 0<α≤2); LiₐNi_{1-b-c}Mn_{b}B′_{c}O_{2-α′}F′_{α} (where 0.90≤a≤1, 0≤b≤0.5, 0≤c≤0.05, 0<α<2); LiₐNi_{b}E_{c}G_{d}O₂ (where 0.90≤a≤1, 0≤b≤0.9, 0≤c≤0.5, 0.001≤d≤0.1); LiₐNiG_{b}O₂ (where 0.90≤a≤1, 0≤b≤0.9, 0≤c≤0.5, 0≤d≤0.5, 0.001≤e≤0.1); LiₐNiG_{b}O₂ (where 0.90≤a≤1, 0.001≤b≤0.1); LiₐCoG_{b}O₂ (where 0.90≤a≤1, 0.001≤b≤0.1); LiₐMnG_{b}O₂ (where 0.90≤a≤1, 0.001≤b≤0.1); LiₐMn₂G_{b}O₄ (where 0.90≤a≤1, 0.001≤b≤0.1); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); and LiFePO₄. In the above Formulae, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; J is V, Cr, Mn, Co, Ni, Cu, or a combination thereof. The cathode active materials may include, for example, LiCoO₂, LiMnₓO₂ₓ (x=1, 2), LiNi₁₋ₓMnₓO₂ₓ (0<x<1), Ni_{1-x-y}CoₓMn_{y}O₂ (0≤x≤0.5, 0≤y≤0.5), LiFePO₄, TiS₂, FeS₂, TiS₃, FeS₃, or the like.

The cathode active material may include, for example, a lithium transition metal oxide represented by Formulae 6 to 13:

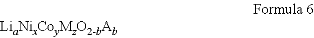

wherein in Formula 6,
1.0≤a≤1.2, 0≤b≤0.2, 0.8≤x<1, 0≤y≤0.3, 0<z≤0.3, and x+y+z=1;
M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof; and
A may be F, S, Cl, Br, or a combination thereof.

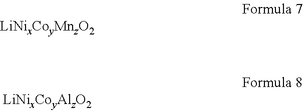

wherein in Formulae 7 to 8, 0.8≤x≤0.95, 0≤y≤0.2, 0<z≤0.2, and x+y+z=1,

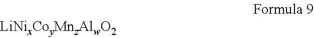

wherein in Formula 9, 0.8≤x≤0.95, 0≤y≤0.2, 0<z≤0.2, 0<w≤0.2, and x+y+z+w=1,

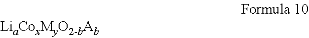

wherein in Formulae 9 and 10,
1.0≤a≤1.2, 0≤b≤0.2, 0.9≤x≤1, 0≤y≤0.1, and x+y=1;
M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof; and
A may be F, S, Cl, Br, or a combination thereof,

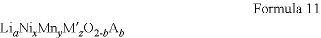

wherein in Formula 11,
1.0≤a≤1.2, 0≤b≤0.2, 0<x≤0.3, 0.5≤y<1, 0<z≤0.3, and x+y+z=1;
M′ may be cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof; and
A may be F, S, Cl, Br, or a combination thereof,

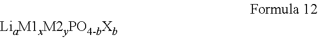

wherein in Formula 12, 0.90≤a≤1.1, 0≤x≤0.9, 0≤y≤0.5, 0.9<x+y<1.1, and 0≤b≤2;
M1 may be chromium (Cr), manganese (Mn), iron (Fe), cobalt (Co), nickel (Ni), copper (Cu), zirconium (Zr), or a combination thereof;
M2 may be magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof; and
X may be O, F, S, P, or any combination thereof.

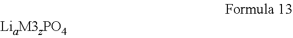

wherein in Formula 13, 0.90≤a≤1.1, 0.9≤z≤1.1; and
M3 may be chromium (Cr), manganese (Mn), iron (Fe), cobalt (Co), nickel (Ni), copper (Cu), zirconium (Zr), or a combination thereof.

The cathode active material may be covered by a coating layer. The coating layer may be any layer known as a coating layer for the cathode active material of a multilayer ceramic battery. The coating layer is, for example, Li₂O—ZrO₂ (LZO).

The size of the cathode active material may be, for example, about 0.1 micrometers (μm) to about 20 μm, about 0.5 μm to about 10 μm or about 1 μm to about 5 μm. The cathode active material may be, for example, a single crystal particle or a polycrystalline particle.

The shape of the cathode active material is, for example, a particle shape such as a sphere, an ellipse, or a sphere. The particle size of the cathode active material is not particularly limited and is within a range applicable to cathode active materials of conventional all solid batteries. The content of the cathode active material of the cathode active material layer 12 is not particularly limited and is within a range generally applied to the cathode active material layer 12 of a lithium battery. The content of the cathode active material included in the cathode active material layer 12 may be about 80 wt % to about 99 wt %, about 80 wt % to about 95 wt %, or about 80 wt % to about 90 wt % of the total weight of the cathode active material layer 12.

The cathode active material layer 12 may further include a solid electrolyte. The solid electrolyte may include, for example, the aforementioned lithium ion conductor. The solid electrolyte may include, for example, an oxide-based solid electrolyte, a sulfide-based solid electrolyte, an oxyhalide-based solid electrolyte, or a combination thereof. The solid electrolyte content of the cathode active material layer 12 may be about 0.1 wt % to about 50 wt %, about 1 wt % to about 40 wt %, or about 10 wt % to about 30 wt % of the total weight of the cathode active material layer 12.

The cathode 10 includes a cathode active material layer 12, and the cathode active material layer 12 may include one or more cathode active material particles and the aforementioned lithium ion conductor disposed on or between the cathode active material particles. A lithium ion conductor may be arranged on the cathode active material particles to form a coating layer on the surface of the cathode active material particles. A lithium ion conductor may be disposed between plural cathode active material particles to provide an ion conduction pathway between the cathode active material particles. The lithium ion conductor, having ductility, may effectively accommodate the volume change of the cathode active material during charging and discharging and maintain the ion conduction pathway. As a result, the reversibility of the electrode reaction of the cathode 10 including a lithium ion conductor and the all solid battery 40 may be improved.

The cathode active material layer 12 may further include a conductive material, a binder, or a combination thereof.

The conductive material may include, for example, a carbon-based conductive material. The carbon-based conductive materials may include, for example, carbon black, carbon fibers, graphite, fluorocarbon, or a combination thereof. The carbon black may be, for example, acetylene black, Ketjen black, Super P carbon, channel black, furnace black, lamp black, thermal black, or a combination thereof. The graphite may be a natural or an artificial graphite. The cathode active material layer 12 may further include a metal-based conductive agent, a metal oxide-based conductive agent, or a polymer-based conductive agent in addition to the aforementioned carbon-based conductive agent. The metal conductive material may be, for example, a metal fiber, a metal powder such as aluminum powder or nickel powder, a conductive metal oxide such as zinc oxide or potassium titanate, or a polyethylene derivative. The content of the conductive agent may be about 1 part to about 10 parts by weight, or about 2 parts to about 7 parts by weight, based on 100 parts by weight of the cathode active material.

A binder may improve the adhesion between components of the cathode active material layer 12, and the adhesion of the cathode active material layer 12 to the cathode current collector 11. The binder may include, for example, polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, copolymers thereof, or a combination thereof. The content of the binder may be about 1 part to about 10 parts by weight, or about 2 parts to about 7 parts by weight, based on 100 parts by weight of the cathode active material. The binder may be omitted.

An interlayer (not shown) disposed between the cathode 10 and the solid electrolyte layer 30 may be further included, and the interlayer may include the aforementioned lithium ion conductor. By arranging an interlayer containing a lithium ion conductor between the cathode 10 and the solid electrolyte layer 30, the adhesion between the cathode 10 and the solid electrolyte layer 30 is improved, thereby reducing the interfacial resistance between the cathode 10 and the solid electrolyte layer 30. As a result, the reversibility of the electrode reaction of a lithium battery including an intermediate layer may be improved.

The cathode current collector 11 may include, for example, a metal-based substrate, a carbon-based substrate, or a combination thereof. As the metal-based substrate, for example, a porous body, mesh, plate or foil made of stainless steel, nickel (Ni), aluminum (Al), indium (In), copper (Cu), magnesium (Mg), titanium (Ti), iron (Fe), cobalt (Co), nickel (Ni), zinc (Zn), germanium (Ge), lithium (Li), or an alloy thereof may be used. The carbon-based substrate may include, for example, one-dimensional carbon-based materials such as carbon fibers or carbon tubes, two-dimensional carbon-based materials such as graphite or graphene, or a combination thereof. The cathode current collector 11 may further include a binder. The binder may be selected from among the binders used in the cathode active material layer 12. The cathode current collector 11 may be omitted.

Next, the anode 20 is prepared.

The anode 20 may be manufactured in the same manner as the cathode 10, except that an anode active material is used instead of the cathode active material. The anode 20 may be prepared by forming an anode active material layer 22 containing an anode active material on an anode current collector 21.

The anode 20 may be prepared, for example, in the following manner. An anode active material composition is prepared by mixing an anode active material, a conductive agent, a binder, and a solvent. The anode 20 may be prepared by directly coating and drying the anode active material composition on the anode current collector 21, or by casting the anode active material film on a separate support and peeling it off from the support and laminating it on the anode current collector 21, thereby obtaining the anode 20. Alternatively, the anode active material composition may be prepared in the form of electrode ink containing an excessive amount of solvent and printed onto an anode current collector 21 using an inkjet or gravure printing method to prepare the anode 20. The printing method is not limited to the above method, and any method that may be used for general coating and printing may be used.

The anode active material layer 22 includes an anode active material.

The anode active material may include, for example, at least one of a lithium metal, a lithium metal alloy, a metal alloyable with lithium, a transition metal oxide, a non-transition metal oxide, or a carbon-based material. The lithium metal alloy is an alloy of lithium and other metals, such as indium. The metal alloyable with lithium may include, for example, Si, Sn, Al, Ge, Pb, Bi, Sb, a Si—Y′ alloy (where Y′ is an alkali metal, an alkaline earth metal, a group 13 element, a group 14 element, a transition metal, a rare earth element or a combination thereof, but not Si), or a Sn—Y′ alloy (where Y′ is an alkali metal, an alkaline earth metal, a group 13 element, a group 14 element, a transition metal, a rare earth element or a combination thereof, but not Sn), or the like. The element Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. The transition metal oxide may include, for example, a lithium titanium oxide, a vanadium oxide, a lithium vanadium oxide, or the like. The non-transition metal oxides may include, for example, SnO₂, SiOₓ (0<x<2).

The carbon-based material may include, for example, a crystalline carbon, an amorphous carbon, or a combination thereof. The crystalline carbon may be a graphite such as a natural graphite or an artificial graphite in the form of amorphous, plate-like, flake-like, spherical, or fibrous particles, and the amorphous carbon may be a soft carbon (low-temperature calcined carbon) or a hard carbon, a mesophase pitch carbide, a calcined coke, or the like. The anode active material may include, for example, a silicon oxide, a silicon-based alloy, a silicon-carbon-based material composite, tin, a tin-based alloy, a tin-carbon composite, a metal oxide, or a combination thereof.

The anode active material layer 22 may additionally include a binder, a conductive material, and the like. The binder and the conductive material may each be selected from the binders and conductive materials used in the aforementioned cathode active material layer 12.

The anode active material layer 22 may further include a solid electrolyte. The solid electrolyte may include, for example, the aforementioned lithium ion conductor. The solid electrolyte may include, for example, an oxide-based solid electrolyte, a sulfide-based solid electrolyte, an oxyhalide-based solid electrolyte, or a combination thereof.

The anode current collector 21 may be selected from the metal-based substrate, carbon-based substrate, or a combination thereof used in the aforementioned cathode current collector 11.

Then, a solid electrolyte layer 30 is prepared. The solid electrolyte layer 30 may include a solid electrolyte. The solid electrolyte may include, for example, the aforementioned lithium ion conductor. The solid electrolyte may include, for example, an oxide-based solid electrolyte, a sulfide-based solid electrolyte, an oxyhalide-based solid electrolyte, or a combination thereof.

The oxide-based solid electrolyte may include, for example, a Garnet-type solid electrolyte, a NASICON-type solid electrolyte, a LISICON-type solid electrolyte, a perovskite-type solid electrolyte, a LiPON-type solid electrolyte, an amorphous (glass) solid electrolyte, or a metal oxide. The solid electrolyte may be prepared, for example, by sintering methods.

The Garnet-type solid electrolyte may include lithium lanthanum zirconium oxide (LLZO), represented by the formula Li₃₊ₓLa_{y}M_{z}O₁₂ (1≤x≤10, 2≤y≤4, 1≤z≤3, where M is Zr, Ga, W, Nb, Ta, Al, or a combination thereof), such as Li₇La₃Zr₂O₁₂ and Li₃₊ₓLa₃Zr₂₋ₐMₐO₁₂ (M-doped LLZO, where M=Ga, W, Nb, Ta, Al, or a combination thereof, 1≤x≤10, 0<a<2).

The NASICON-type solid electrolyte may include lithium aluminum titanium phosphate (LATP), such as Li₁₊ₓAlₓTi₂₋ₓ(PO₄)₃ (0<x<1), which is a Ti-doped lithium aluminum phosphate compound Li₁₊ₓAlₓM₂₋ₓ(PO₄)₃ (0<x<2, where M is Zr, Ti, Ge, or a combination thereof, LAMP), and lithium aluminum germanium phosphate (LAGP), represented by Li₁₊ₓAlₓGe₂₋ₓ(PO₄)₃ (0<x<1), such as Li_{1·3}Al_{0·3}Ti_{1·7}(PO₄)₃. It may also include lithium zirconium phosphate (LZP), represented by LiZr₂(PO₄)₃.

The LISICON-type solid electrolyte may be represented by xLi₃AO₄-(1-x)Li₄BO₄ (where A is P, As, or V, and B is Si, Ge, or Ti). It may also include solid solution oxides such as Li₄Zn(GeO₄)₄, Li₁₀GeP₂O₁₂ (LGPO), Li_{3·5}Si_{0·5}P_{0·5}O₄, and Li_{10·42}Si(Ge)_{1·5}P_{1·5}Cl_{0·08}O_{11·92}.

The perovskite-type solid electrolyte may include lithium-lanthanum-titanium-oxide (LLTO), represented by Li₃ₓLa_{2/3-x1/3-2x}TiO₃ (0<x<0.16), such as Li_{1/8}La_{5/8}TiO₃.

The LIPON-type solid electrolyte may include oxynitride compounds such as Li_{2·8}PO_{3·3}N_{0·46}, which is a lithium-phosphorus-oxynitride.

The amorphous electrolyte may include Li₂O—B₂O₃—SiO₂, Li₂O—B₂O₃—P₂O₅, Li₃BO₃—Li₂SO₄, or Li₃BO₃—Li₂CO₃.

The metal oxide electrolyte may include, for example, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, Li₂O, LiOH, Li₂CO₃, or LiAlO₂.

The oxide-based solid electrolyte may include, for example, Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y} Ti_{y}O₃(PLZT)(O≤x<1, O≤y<1), Pb(Mg₃Nb_{2/3})O₃—PbTiO₃(PMN-PT), LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1 0≤y≤1), LiₓLa_{y}TiO₃ (0<x<2, 0<y<3), Li₂O—Al₂O₃—SiO₂—P₂O₅—TiO₂—GeO₂, Li₃₊ₓLa₃M₂O₁₂ (where M=Te, Nb, or Zr, and x is an integer from 1 to 10).

The sulfide-based solid electrolyte may include, for example, lithium sulfide, silicon sulfide, phosphorus sulfide, boron sulfide, or a combination thereof. The sulfide-based solid electrolyte particles may include Li₂S, P₂S₅, SiS₂, GeS₂, B₂S₃ or a combination thereof. The sulfide-based solid electrolyte particles can be Li₂S or P₂S₅. The sulfide-based solid electrolyte particles are known to have higher lithium ion conductivity than other inorganic compounds. For example, the sulfide-based solid electrolyte may include Li₂S and P₂S₅. When the sulfide solid electrolyte material constituting the solid electrolyte includes Li₂S—P₂S₅, the mixing molar ratio of Li₂S to P₂S₅ may be, for example, in the range of about 50:50 to about 90:10. The sulfide-based solid electrolyte may include an inorganic solid electrolyte prepared by adding Li₃PO₄, a halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“Thio-LISICON”), Li₂O—Al₂O₃—TiO₂—P₂O₅ (“LATP”), Li₂S—P₂S₅, SiS₂, GeS₂, B₂S₃, or a combination thereof. Non-limiting examples of the sulfide-based solid electrolyte materials include Li₂S—P₂S₅; Li₂S—P₂S₅—LiX (X is a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (where m and n are positive numbers, and Z is Ge, Zn, or G); Li₂S—GeS₂; Li₂S—SiS₂—Li₃PO₄; and Li₂S—SiS₂—LiₚMO_{q} (where p and q are positive numbers, and M is P, Si, Ge, B, Al, Ga or In). In this regard, the sulfide-based solid electrolyte material is prepared by processing precursor materials of sulfide-based solid electrolytes (e.g., Li₂S, P₂S₅, etc.) through methods such as melt quenching or mechanical milling. Additionally, a calcination process may be performed after these treatment.

The oxyhalide-based solid electrolyte may include, for example, a first compound represented by the aforementioned Formulae 1 to 4I.

The solid electrolyte layer 30 may be prepared, for example, by mixing and drying a solid electrolyte including the aforementioned lithium ion conductor with a binder, or by pressing a solid electrolyte powder including the aforementioned lithium ion conductor into a specific shape. The solid electrolyte layer 30 may be prepared, for example, by mixing and drying a solid electrolyte including the aforementioned lithium ion conductor with a sulfide-based and/or oxide-based solid electrolyte and a binder, or by pressing a solid electrolyte powder including the aforementioned lithium ion conductor and a sulfide-based and/or oxide-based solid electrolyte powder into a specific shape. The solid electrolyte layer 30 may be prepared, for example, by mixing and drying a sulfide-based and/or oxide-based solid electrolyte with a binder, or by pressing a sulfide-based and/or oxide-based solid electrolyte powder into a specific shape.

The solid electrolyte may be deposited using a film forming method such as blasting, aerosol deposition, cold spraying, sputtering, chemical vapor deposition (CVD), or spraying, thereby forming a solid electrolyte layer 30. Alternatively, the solid electrolyte layer 30 may be formed by pressurizing the solid electrolyte. Additionally, the solid electrolyte layer 30 may be formed by mixing and pressurizing a solid electrolyte, a solvent, and a binder or a support. The solvent or the support may be added to reinforce the strength of the solid electrolyte layer 30 or to prevent short-circuiting of the solid electrolyte.

The binder included in the solid electrolyte layer 30 may be selected from the binders used in the cathode active material layer 12, but is not limited thereto, and any binder used in the relevant technical field may be used.

Referring to FIG. 7, the all solid battery 40 may include a solid electrolyte layer 30, a cathode 10 arranged on one side of the solid electrolyte layer 30, and an anode 20 arranged on the other side of the solid electrolyte layer 30. The cathode 10 may include a cathode active material layer 12 in contact with the solid electrolyte layer 30 and a cathode current collector 11 in contact with the cathode active material layer 12, and the anode 20 may include an anode active material layer 22 in contact with the solid electrolyte layer 30 and an anode current collector 21 in contact with the anode active material layer 22. The all solid battery 40 may be formed by forming the cathode active material layer 12 and the anode active material layer 22 on both sides of the solid electrolyte layer 30, and forming the cathode current collector 11 and the anode current collector 21 on the cathode active material layer 12 and the anode active material layer 22, respectively, thereby completing an all solid secondary battery 40. Alternatively, an all solid secondary battery 40 may be completed by sequentially stacking the anode current collector 21, the anode active material layer 22, the solid electrolyte layer 30, the cathode active material layer 12, and the cathode current collector 11.

Type 2: All Solid Battery with a Precipitation Type Anode

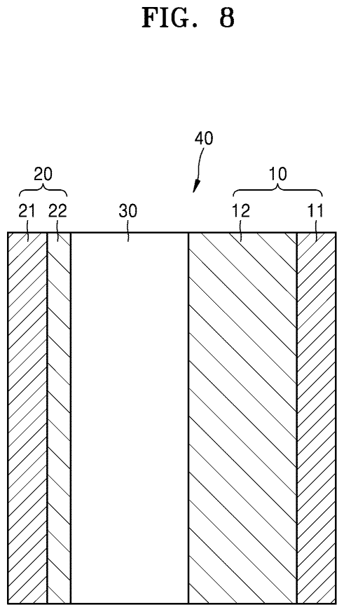

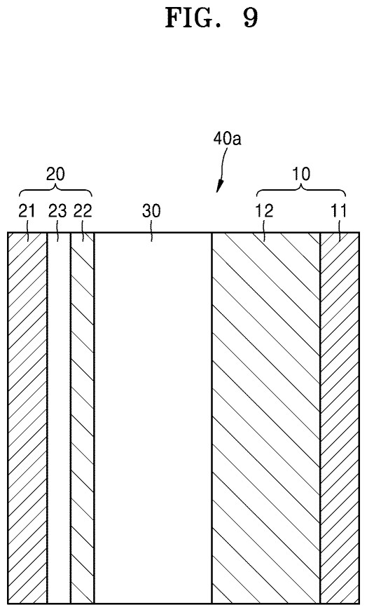

FIGS. 8 to 9 are schematic diagrams of an all solid battery including a precipitation type anode according to an embodiment. In an all solid battery with a precipitation type anode, the initial charge capacity of the anode active material layer during the initial charge is, for example, 50% or less, 40% or less, 30% or less, 20% or less, 10% or less, 5% or less, or 1% or less of the initial charge capacity of the cathode active material layer. The all solid battery 40 may include, for example, the cathode 10 including a cathode active material layer 12 arranged on a cathode current collector 11; an anode 20 including an anode active material layer 22 arranged on an anode current collector 21; and an electrolyte layer 30 arranged between the cathode 10 and the anode 20, wherein the cathode active material layer 12 and/or the electrolyte layer 30 include a solid electrolyte.

An all solid battery 40 may be prepared as follows.

The cathode 10 and the solid electrolyte layer 30 may be prepared in the same manner as the all solid secondary battery having the aforementioned non-precipitation type anode.

Next, the anode 20 is prepared.

Referring to FIGS. 8 to 9, the anode 20 may include an anode current collector 21 and an anode active material layer 22 disposed on the anode current collector 21, and the anode active material layer 22 may include, for example, an anode active material and a binder.

The anode active material included in the anode active material layer 22 may be, for example, in particle form. The average particle size of the anode active material in particle form may be, for example, 4 μm or less, 3 μm or less, 2 μm or less, 1 μm or less, or 900 nanometers (nm) or less. The average particle size of the anode active material in particle form may be, for example, about 10 nm to about 4 μm or less, about 10 nm to about 3 μm or less, about 10 nm to about 2 μm or less, about 10 nm to about 1 μm or less, or about 10 nm to about 900 nm or less. By having an anode active material with an average particle diameter within this range, the reversible absorption and/or desorption of lithium during charging and discharging may be further facilitated. The average particle diameter of the anode active material may be, for example, the median diameter (D50) measured using a laser particle size distribution analyzer.

The anode active material included in the anode active material layer 22 may include, for example, at least one selected from a carbon-based anode active material and a metal or metalloid anode active material.

The carbon-based anode material is particularly amorphous carbon. Examples of amorphous carbon may include, but is not limited to, carbon black (CB), acetylene black (AB), furnace black (FB), ketjen black (KB), and graphene. Any material classified as amorphous carbon in the relevant technical field may be used. Amorphous carbon is a non-crystalline or very low-crystalline carbon, distinguishing it from crystalline carbon or graphite-based carbon.

The metal or metalloid anode active material may include at least one of gold (Au), platinum (Pt), palladium (Pd), silicon (Si), silver (Ag), aluminum (Al), bismuth (Bi), tin (Sn), or zinc (Zn), but is not necessarily limited thereto, and any metal or metalloid anode active material that forms an alloy or compound with lithium in the relevant technical field may be used. For example, nickel (Ni) may not be considered a metallic anode active material as it does not form an alloy with lithium.

The anode active material layer 22 may include a single type of anode active material or a mixture of plural different anode active materials. For example, the anode active material layer 22 may include only amorphous carbon, or at least one of gold (Au), platinum (Pt), palladium (Pd), silicon (Si), silver (Ag), aluminum (Al), bismuth (Bi), tin (Sn), or zinc (Zn). Alternatively, the anode active material layer 22 may include a mixture of amorphous carbon and at least one of gold (Au), platinum (Pt), palladium (Pd), silicon (Si), silver (Ag), aluminum (Al), bismuth (Bi), tin (Sn), or zinc (Zn). The mixing ratio of amorphous carbon and metals such as gold in the mixture may be in a weight ratio of, for example, about 10:1 to about 1:2, about 5:1 to about 1:1, or about 4:1 to about 2:1. However, this range is not strictly limited and may be adjusted based on the required characteristics of the all solid battery 40. By having the anode active material with this composition, the cycle characteristics of the all solid battery 40 are further improved.

The anode active material included in the anode active material layer 22 may include, for example, a mixture of first particles made of amorphous carbon and second particles made composed of a metal or metalloid. The metal or metalloid may include, for example, gold (Au), platinum (Pt), palladium (Pd), silicon (Si), silver (Ag), aluminum (Al), bismuth (Bi), tin (Sn), and zinc (Zn). Alternatively, the metalloid may be a semiconductor. The content of the second particles is about 8 wt % to about 60 wt %, about 10 wt % to about 50 wt %, about 15 wt % to about 40 wt %, or about 20 wt % to about 30 wt % based on the total weight of the mixture. By having the second particle with a content in this range, the cycle characteristics of the all solid battery 40 may be further improved.

The binder included in the anode active material layer 22 may be, for example, styrene-butadiene rubber (SBR), polytetrafluoroethylene, polyvinylidene fluoride, polyethylene, vinylidene fluoride/hexafluoropropylene copolymer, polyacrylonitrile, polymethyl methacrylate, or the like. However, it is not limited to these, and any binder commonly used in the relevant technical field may be applied. The binder may be composed of a single type of binder or a combination of plural different binders.

By including a binder in the anode active material layer 22, the anode active material layer 22 may be stabilized on the anode current collector 21. Additionally, during charging and discharging, the binder helps suppress cracking in the anode active material layer 22, even when there are volume changes or relative positional changes. For example, when the anode active material layer 22 does not include a binder, the anode active material layer 22 may easily detach from the anode current collector 21. As the anode active material layer 22 is detached from the anode current collector 21, there is an increased risk of a short circuit occurring at the exposed portion of the anode current collector 21, due to the contact between the anode current collector 21 and the solid electrolyte layer 30. The anode active material layer 22 may be prepared by, for example, applying a slurry, in which the constituent materials of the anode active material layer 22 are dispersed, onto the anode current collector 21, and drying it. By including a binder, the anode active material layer 22 may be stably dispersed in the slurry. For example, when applying the slurry onto the anode current collector 21 using screen printing, the binder may prevent clogging of the screen (e.g., clogging caused by aggregates of the anode active material).

The anode active material layer 22 may further include additives used in conventional all solid batteries 40, such as fillers, coating agents, dispersants, and ion conductive assistants.

The thickness of the anode active material layer 22 may be, for example, 50% or less, 40% or less, 30% or less, 20% or less, 10% or less, or 5% or less of the thickness of the cathode active material layer 12, 12a, 12b. The thickness of the anode active material layer 22 may be, for example, about 1 μm to about 20 μm, about 2 μm to about 10 μm, or about 3 μm to about 7 μm. If the thickness of the anode active material layer 22 is too thin, lithium dendrites formed between the anode active material layer 22 and the anode current collector 21 may cause the anode active material layer 22 to collapse, making it difficult to improve the cycle characteristics of the all solid battery 40. If the thickness of the anode active material layer 22 increases excessively, the energy density of the all solid battery 40 decreases and the internal resistance of the all solid battery 40 due to the anode active material layer 22 increases, making it difficult to improve the cycle characteristics of the all solid battery 40.

If the thickness of the anode active material layer 22 decreases, for example, the charging capacity of the anode active material layer 22 also decreases. The charge capacity of the anode active material layer 22 is, for example, 50% or less, 40% or less, 30% or less, 20% or less, 10% or less, 5% or less, 2% or less, or 1% or less compared to the charge capacity of the cathode active material layer 12. The charge capacity of the anode active material layer 22 is, for example, about 0.1% to about 50%, about 0.1% to about 40%, about 0.1% to about 30%, about 0.1% to about 20%, about 0.1% to about 10%, about 0.1% to about 5%, or about 0.1% to about 2% compared to the charge capacity of the cathode active material layer 12. If the charge capacity of the anode active material layer 22 is too small, the thickness of the anode active material layer 22 becomes very thin, so that lithium dendrites formed between the anode active material layer 22 and the anode current collector 21 during repeated charging and discharging may collapse the anode active material layer 22, making it difficult to improve the cycle characteristics of the all solid battery 40. If the charge capacity of the anode active material layer 22 increases excessively, the energy density of the all solid battery 40 decreases and the internal resistance of the all solid battery 40 due to the anode active material layer 22 increases, making it difficult to improve the cycle characteristics of the all solid battery 40.

The charge capacity of the cathode active material layer 12 is obtained by multiplying the charge capacity density (milliampere-hours per gram (mAh/g)) of the cathode active material by the mass of the cathode active material in the cathode active material layer 12. When several types of cathode active materials are used, the charge capacity density×mass value is calculated for each cathode active material, and the sum of these values is the charge capacity of the cathode active material layer 12. The charge capacity of the anode active material layer 22 is also calculated in the same way. That is, the charge capacity of the anode active material layer 22 is obtained by multiplying the charge capacity density (mAh/g) of the anode active material by the mass of the anode active material in the anode active material layer 22. When several types of anode active materials are used, the charge capacity density×mass value is calculated for each anode active material, and the sum of these values is the capacity of the anode active material layer 22. Here, the charge capacity density of the cathode active material and the anode active material is the estimated capacity obtained using an all solid half-cell with lithium metal as the counter electrode. The charge capacity of the cathode active material layer 12 and the anode active material layer 22 is directly measured by measuring the charge capacity using an all solid half-cell. By dividing the measured charge capacity by the mass of each active material, the charge capacity density is obtained. Alternatively, the charge capacity of the cathode active material layer 12 and the anode active material layer 22 may be the initial charge capacity measured at the time of the first charge cycle.

Referring to FIG. 9, the all solid battery 40a may further include, for example, a metal layer 23 disposed between the anode current collector 21 and the anode active material layer 22. The metal layer 23 may be a metal foil or a plated metal layer. The metal layer 23 may include lithium or a lithium alloy. Therefore, the metal layer 23 may function, for example, as a lithium reservoir. The lithium alloy may include, but is not limited to, a Li—Al alloy, a Li—Sn alloy, a Li—In alloy, a Li—Ag alloy, a Li—Au alloy, a Li—Zn alloy, a Li—Ge alloy, a Li—Si alloy, but any lithium alloy used in the relevant technical field may be used. The metal layer 23 may include lithium, one of these alloys, or a combination of multiple lithium alloys.

The thickness of the metal layer 23 is not particularly limited, but may be, for example, about 1 μm to about 200 μm, about 1 μm to about 100 μm, about 1 μm to about 70 μm, about 1 μm to 50 μm, about 1 μm to about 30 μm, or about 1 μm to 20 μm. If the thickness of the metal layer 23 is too thin, it is difficult for the metal layer 23 to perform the role of a lithium reservoir. If the thickness of the metal layer 23 is too thick, the mass and volume of the all solid battery 40 may increase and the cycle characteristics may deteriorate. The metal layer 23 may be, for example, a metal foil having a thickness within this range.

In the all solid battery 40a, the metal layer 23 may be, for example, placed between the anode current collector 21 and the anode active material layer 22 before assembling the all solid battery 40a, or be precipitated between the anode current collector 21 and the anode active material layer 22 by charging after assembling the all solid battery 40a. If the metal layer 23 is placed between the anode current collector 21 and the anode active material layer 22 before assembling the all solid battery 40a, the metal layer 23 functions as a lithium reservoir since it is a lithium-containing metal layer. For example, before assembling the all solid battery 40a, a lithium foil may be placed between the anode current collector 21 and the anode active material layer 22. Thereby, the cycle characteristics of the all solid battery 40a including the metal layer 23 are further improved. When the metal layer 23 is precipitated by charging after assembling the all solid battery 1a, the energy density of the all solid battery 40a increases because the metal layer 23 is not included when assembling the all solid battery 40a. For example, when charging an all solid battery 40a, the charging is performed in excess of the charging capacity of the anode active material layer 22. That is, the anode active material layer 22 is overcharged. During the initial stage of charging, lithium is absorbed into the anode active material layer 22. The anode active material included in the anode active material layer 22 forms an alloy or compound with the lithium ions that have moved from the cathode 10. When the charging exceeds the capacity of the anode active material layer 22, for example, lithium is precipitated at the rear side of the anode active material layer 22, that is, between the anode current collector 21 and the anode active material layer 22, and the precipitated lithium forms a metal layer corresponding to the metal layer 23. The metal layer 23 is a metal layer including mainly lithium (i.e., metallic lithium). These results are obtained, for example, by the anode active material included in the anode active material layer 22 being composed of a material that forms an alloy or compound with lithium. During discharge, the anode active material layer 22 and the metal layer 23, that is, the lithium in the metal layer ionizes and moves toward the cathode 10. Therefore, it is possible to use lithium as an anode active material in an all solid battery 40a. In addition, since the anode active material layer 22 coats the metal layer 23, it acts as a protective layer for the metal layer, i.e., the metal layer 23, and at the same time, it plays a role in suppressing the precipitation and growth of lithium dendrites. Accordingly, short-circuits and capacity degradation of the all solid battery 40a are suppressed, and as a result, the cycle characteristics of the all solid battery 40a are improved. In addition, when the metal layer 23 is placed by charging after assembling the all solid battery 40a, the anode current collector 21, the anode active material layer 22, and the region between them are Li-free regions that do not contain lithium (Li), for example, in the initial state or after discharge state of the all solid battery 40a.

The anode current collector 21 may include, for example, a material that does not react with lithium, i.e., does not form an alloy or compound with lithium. The material constituting the anode current collector 21 may include, but are not necessarily limited to, copper (Cu), stainless steel, titanium (Ti), iron (Fe), cobalt (Co), and nickel (Ni), and any material that may be used as an electrode current collector in the relevant technical field may be used. The anode current collector 21 may include a single type of metal from the aforementioned metals, or an alloy or coated material of two or more metals. The anode current collector 21 may be, for example, in the form of a plate or foil.

The all solid battery 40, 40a may further include, for example, a thin film (not shown) containing an element capable of forming an alloy with lithium on the anode current collector 21. The thin film may be placed between the anode current collector 21 and the anode active material layer 22. The thin film may include, for example, elements that can form an alloy with lithium. The elements capable of forming an alloy with lithium include, but are not limited to, gold (Au), silver (Ag), zinc (Zn), tin (Sn), indium (In), silicon (Si), aluminum (Al), and bismuth (Bi). Any element capable of forming an alloy with lithium in the relevant technical field may be used. The thin film may include one of these metals, or of an alloy of several types of metals. By placing the thin film on the anode current collector 21, for example, the precipitation shape of the metal layer 23 precipitated between the thin film 24 and the anode active material layer 22 is further flattened, and the cycle characteristics of the all solid battery 40, 40a may be further improved.

The thickness of the thin film is, for example, about 1 nm to about 800 nm, about 10 nm to about 700 nm, about 50 nm to about 600 nm, or about 100 nm to about 500 nm. If the thickness of the thin film is less than 1 nm, it may be difficult for the thin film to perform its function. If the thickness of the thin film is too thick, the thin film itself absorbs lithium, which reduces the amount of lithium precipitation from the anode, lowering the energy density of the all solid battery and deteriorating the cycle characteristics of the all solid battery 40, 40a. The thin film may be formed on the anode current collector 21 by, for example, a vacuum deposition method, a sputtering method, a plating method, or the like, but is not necessarily limited to these methods, and any method capable of forming a thin film in the relevant technical field is possible.

### Multilayer Ceramic All Solid Battery

A multilayer ceramic all solid battery is a small or ultra-small battery that may be applied as power sources for Internet of Things (IoT) applications and wearable devices. The multilayer ceramic all solid battery may also be applied to medium- and larger-scaled batteries, such as electric vehicles (EVs) and energy storage systems (ESS).

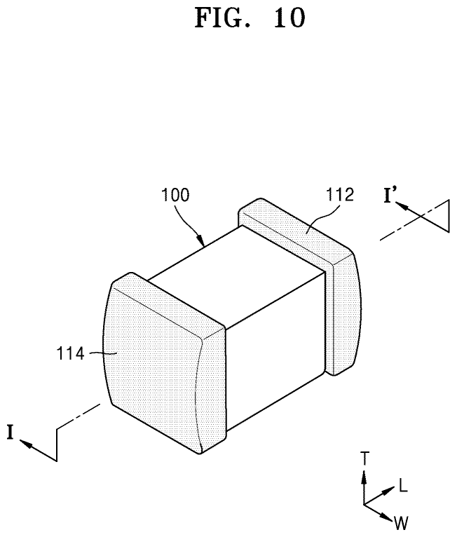

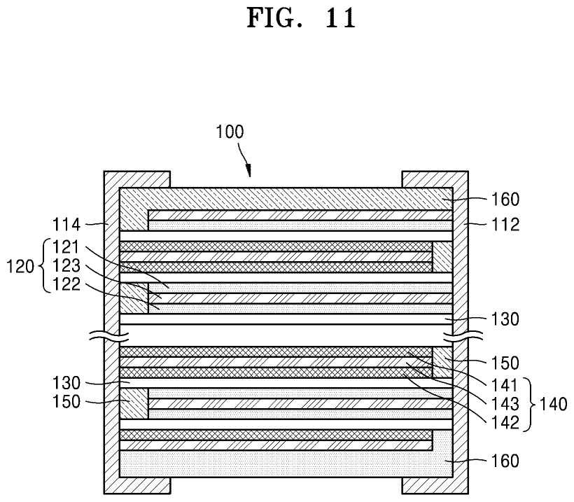

FIG. 10 is a perspective view schematically illustrating a multilayer ceramic (MLC) all solid battery 100 according to an embodiment. FIG. 11 is a cross-sectional view of a multilayer ceramic (MLC) all solid battery according to an embodiment. Referring to FIGS. 10 and 11, in a multilayer ceramic all solid battery 100, two opposing surfaces in the thickness direction (T-axis direction) are defined as a first surface and a second surface, and two opposing surfaces connected to the first surface and the second surface in the length direction (L direction) are defined as a third surface and a fourth surface. For example, the first and second opposing side surfaces of the multilayer ceramic all solid battery 100 may correspond to the third and fourth surfaces.

The multilayer ceramic all solid battery 100 may include a cathode 120, an anode 140, and a solid electrolyte layer 130 arranged in a stacking direction between the cathode 120 and the anode 140. The cathode 120 may include a cathode current collector 123 and a cathode active material layer 121, 122 disposed on one or both surfaces of the cathode current collector 123. The anode 140 may include an anode current collector 143 and an anode active material layer 141, 142 disposed on one or both surfaces of the anode current collector 143.

The cathode active material layer 121, 122 may include a cathode active material. The cathode active material may be selected from the cathode active materials used in the all solid batteries described in FIGS. 7 to 9.

The cathode active material layer 121, 122 may further include a solid electrolyte. The solid electrolyte may include the aforementioned lithium ion conductor. The solid electrolyte may include, for example, an oxide-based solid electrolyte, an oxyhalide-based solid electrolyte, or a combination thereof.

The solid electrolyte content of the cathode active material layer 121, 122 may be about 0.1 wt % to about 50 wt %, about 1 wt % to about 40 wt %, or about 10 wt % to about 30 wt % of the total weight of the cathode active material layer 121, 122.

The cathode active material layer 121, 122 may further include a conductive material, a binder, or a combination thereof.

The conductive material and/or binder may be selected from the conductive materials and/or binders used in the all solid batteries described in FIGS. 7 to 9. The contents of the conductive material and binder used in the active material layers 121, 122 may be selected from the contents of the conductive material and binder used in the all solid batteries described in FIGS. 7 to 9. The binder may be partially or completely removed by vaporization and/or carbonization during the sintering process of the cathode active material layer 121, 122. The binder may be omitted.

The cathode current collector 123 may include, for example, a metal-based substrate, a carbon-based substrate, or a combination thereof. As the metal substrate, for example, a porous body, mesh, plate or foil made of stainless steel, nickel (Ni), aluminum (Al), indium (In), copper (Cu), magnesium (Mg), titanium (Ti), iron (Fe), cobalt (Co), nickel (Ni), zinc (Zn), germanium (Ge), lithium (Li), or an alloy thereof may be used. The cathode current collector 123 may be, for example, a sintered product of metal powder used in the aforementioned metal substrate. The carbon-based substrate may include, for example, one-dimensional carbon-based materials such as carbon fibers or carbon tubes; two-dimensional carbon-based materials such as graphite or graphene; or a combination thereof. The cathode current collector 123 may further include a binder. The binder may be selected from the binders used in the cathode active material layer 121, 122. The cathode current collector 123 may be omitted.

The anode active material layer 141, 142 may include an anode active material. The anode active material may be selected from the anode active materials used in the all solid batteries described in FIGS. 7 to 9.

The anode active material layer 141, 142 may further include a solid electrolyte. The solid electrolyte may include the aforementioned lithium ion conductor. The solid electrolyte may include, for example, an oxide-based solid electrolyte, an oxyhalide-based solid electrolyte, or a combination thereof. The solid electrolyte content of the anode active material layer 141, 142 may be about 0.1 wt % to about 50 wt %, about 1 wt % to about 40 wt %, or about 10 wt % to about 30 wt % of the total weight of the anode active material layer 141, 142.

The anode active material layer 141, 142 may further include a conductive material, a binder, or a combination thereof.

The conductive material and the binder may be selected from the conductive materials and binders used in the cathode active material layer 121, 122, respectively. The contents of the conductive material and binder used in the anode active material layer 141, 142 may be selected from the contents of the conductive material and binder used in the cathode active material layer 121, 122. The binder may be partially or completely removed by vaporization and/or carbonization during the sintering process of the anode active material layer 141, 142. The binder may be omitted.

The anode current collector 143 may be selected from the metal-based substrate or carbon-based substrate used in the cathode current collector 123.

The solid electrolyte layer 130 may be arranged in a stacking direction, for example, between the cathode active material layer 121, 122 of the cathode 120 and the anode active material layer 141, 142 of the anode 140. In the multilayer ceramic all solid battery 100, a plurality of cathodes 120 and anodes 140 may be arranged alternately in the stacking direction, and a plurality of solid electrolyte layers 130 may be arranged between the cathodes 120 and anodes 140 that are arranged alternately in the stacking direction. The multilayer ceramic all solid battery 100 may be prepared by alternately arranging a plurality of cathodes 120 and a plurality of anodes 140 in a stacking direction, interposing a plurality of solid electrolyte layers 130 between each of the alternately arranged cathodes 120 and anodes 140, and preparing an electrode-electrolyte laminate, and then sintering the electrode-electrolyte laminate at once.

The solid electrolyte layer 130 may include an oxide-based solid electrolyte, an oxyhalide-based solid electrolyte, or a combination thereof. The solid electrolyte layer 130 may include the aforementioned lithium ion conductor. The oxide-based solid electrolyte and the oxyhalide-based solid electrolyte may be selected from the oxide-based solid electrolyte and the oxyhalide-based solid electrolyte used in the all solid battery of FIGS. 7 to 9.

The solid electrolyte layer 130 may further include a binder. The binder may be selected from the binders used in the cathode active material layer 121, 122. The content of binder used in the solid electrolyte layer 130 may be selected from the contents of binder used in the cathode active material layer 121, 122. The binder may be partially or completely removed by vaporization and/or carbonization during the sintering process of the solid electrolyte layer 130. The binder may be omitted.

A margin layer 150 may be arranged along the sides of the cathode 120 and the anode 140, at least partially surrounding the cathode 120 and the anode 140. The margin layer 150 may be disposed on the solid electrolyte layer 130, and may be disposed along the sides adjacent to the cathode active material layers 121, 122 and/or the anode active material layers 141, 142, partially surrounding at least a portion of the cathode active material layer 121, 122 and/or the anode active material layer 141, 142. The margin layer 150 may be arranged on the same layer as the cathode active material layer 121, 122 and/or the anode active material layer 141, 142.

The margin layer 150 may include, for example, an insulating material or a conductive material. The margin layer 150 may include, for example, an insulator having an ionic conductivity of 1/100 or less or 1/1000 or less than that of the solid electrolyte layer 130. The margin layer 150 may include, for example, an insulating polymer. The insulating polymers may include, but are not limited to, polyolefins such as polyethylene and polypropylene, polyesters such as polyethylene terephthalate (PET), polyurethanes, polyimides, and the like.

The margin layer 150 may include, for example, an inorganic solid electrolyte. The margin layer 150 may include, for example, an oxide-based solid electrolyte, a sulfide-based solid electrolyte, or a combination thereof. The margin layer 150 may include, for example, a solid electrolyte used in the solid electrolyte layer 130.

The cathode 120, the solid electrolyte layer 130, the anode 140, and the margin layer 150 may be laminated as described above to form an electrode-electrolyte laminate. A protective layer 160 may be placed on the top and bottom of the electrode-electrolyte laminate. The protective layer 160 may include, for example, an insulating material.

The terminals of the cathode current collector 123 and the terminals of the anode current collector 143 are exposed on both sides of the electrode-electrolyte laminate of the multilayer ceramic all solid battery 100. The exposed terminals are connected and bonded to external electrodes 112 and 114. The external electrode 112 connected to the exposed terminal of the cathode current collector 123 may act as the cathode. The external electrode 114 connected to the exposed terminal of the anode current collector 143 may act as the anode.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or alloys thereof.

The glass component included in the external electrodes 112 and 114 may be a mixture of oxides. The glass component may include, for example, silicon oxide, boron oxide, aluminum oxide, a transition metal oxide, an alkali metal oxide, an alkaline earth metal oxide, or a combination thereof. The transition metal included in the glass component may be one of zinc (Zn), titanium (Ti), copper (Cu), vanadium (V), manganese (Mn), iron (Fe), or nickel (Ni). The alkali metal may be one of lithium (Li), sodium (Na), or potassium (K), and the alkaline earth metal may be one of magnesium (Mg), calcium (Ca), strontium (Sr), or barium (Ba).

The external electrodes 112 and 114 may be formed, for example, by dipping the cell stack into a conductive paste containing a conductive metal and glass. The external electrodes 112 and 114 may be formed, for example, by printing the conductive paste onto the surface of the cell laminate using a screen printing method or a gravure printing method. The external electrodes 112 and 114 may be formed, for example, by applying the conductive paste onto the surface of the cell stack or by transferring a dried film of conductive paste to the cell stack.

### Method of Preparing a Lithium Ion Conductor

The method of preparing a lithium ion conductor according to another embodiment includes mixing a lithium precursor, a zirconium precursor, a dopant precursor, and a chlorine precursor to preparing a mixture; and mechanically milling the mixture to prepare the lithium ion conductor. The lithium ion conductor includes a first compound represented by Formula 1, wherein the first compound includes a crystalline phase belonging to the P-3m1 space group of a trigonal crystal system:

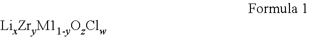

wherein in Formula 1,
M1 may contain one or more elements belonging to groups 3 to 15 of the periodic table, and
1≤x≤3, 0.2<y<1, 0.5≤z≤1.5, 3.5≤w≤4.5 and 4.5≤z+w≤5.5.

Therefore, a lithium ion conductor prepared by this method may provide excellent ion conductivity.

First, the mixture is prepared. The mixture may be prepared by mixing a lithium precursor, a zirconium precursor, a dopant M1 precursor and a chlorine precursor.

The lithium precursor may include, for example, a lithium-containing oxide, a lithium-containing hydroxide, a lithium-containing carbonate, a lithium-containing halogen salt, or a combination thereof. Examples of the lithium precursor include Li₂O, LiOH, and Li₂CO₃.

The zirconium precursor may include, for example, a zirconium-containing chloride, a zirconium-containing oxide, or a combination thereof. The zirconium precursor may include, for example, ZrCl₄, ZrO₂ or a combination thereof.

The dopant M1 precursor may include, for example, a dopant M1-containing chloride, a dopant M1-containing oxide, or a combination thereof. The dopant M1 precursor may include, for example, M1Clₓ (1≤x≤6), M1O_{y} (1≤y≤3) or a combination thereof. The dopant M1 precursor may include, for example, TaCl₅, NbCl₅, HfCl₄, SnCl₄, ScCl₃, YCl₃, AlCl₃, InCl₃, SbCl₅ or combinations thereof.

The chlorine precursor may include, for example, a lithium-containing chloride, a zirconium-containing chloride, an M1-containing chloride, or a combination thereof. The chlorine precursor may include, for example, LiCl, ZrCl₄, M1Clₓ (1≤x≤6) or a combination thereof.

The chlorine precursor may not need to be added separately. A precursor containing chlorine from the lithium precursor, zirconium precursor, and dopant M1 precursor described above may be used as a chlorine precursor.

The oxygen precursor may not be added separately. A precursor containing oxygen from the lithium precursors, boron precursors, M1 precursors and halogen precursors described above may be used as an oxygen precursor.

Alternatively, the oxygen precursor may be added separately. The oxygen precursor may include, for example, a lithium-containing oxide, a zirconium-containing oxide, a dopant M1-containing oxide, or a combination thereof. Examples of the oxygen precursor include Li₂O, and LiOH.

The contents of the lithium precursor, zirconium precursor, dopant M1 precursor and chlorine precursor included in the mixture may be adjusted depending on the composition of the required lithium ion conductor.

Next, the prepared mixture undergoes mechanically milling to prepare a lithium ion conductor including the first compound represented by Formula 1.

The mechanical milling may be performed, for example, a dry process. The lithium-ion conductor may be formed through mechano-chemical reactions that occur during the mechanical milling process.

The mechanical milling may be performed, for example, by ball milling. The size of the balls and the size of the milling container used in ball milling may be selected based on the desired composition and crystal structure of the lithium-ion conductor. The mixture and balls may be placed into the milling container, and milling may be performed. The mechanical milling may be performed for example at a speed ranging from about 100 revolutions per minute (rpm) to about 10000 rpm for periods from about 1 minute to about 300 hours. The mechanical milling process may be performed using a cycling method, where a milling time and rest time are alternated repeatedly. The mechanical milling may be performed using a sequential method, where a fixed milling time and a fixed rest time are alternately repeated.

It is well known in the art that the energy applied to the mixture varies depending on the mechanical milling conditions, and that the composition and/or crystal structure of the lithium ion conductor produced may vary depending on the magnitude of the applied energy and the interval at which the energy is applied. Lithium ion conductors with the same composition may have different crystal structures depending on differences in mechanical milling conditions. For example, reference is made to FIG. 2.

Mechanical milling may be performed, for example, in an air atmosphere or in an inert atmosphere. The air atmosphere may contain oxygen. The inert atmosphere may be an oxygen-free atmosphere. The inert atmosphere may include, for example: nitrogen, argon, neon, helium, or a combination thereof.

Hereinafter, the disclosure will be described in detail with reference to examples and comparative examples, but is not limited to the following examples.

### Preparation of Lithium Ion Conductor

### Example 1

A mixture was prepared by stoichiometrically mixing the following precursors: LiCl (a chlorine-containing precursor), Li₂O (a lithium and oxygen-containing precursor), ZrCl₄ (a zirconium-containing precursor) and TaCl₅ (a dopant M1-containing precursor).

The mixture was placed in a high energy ball mill together with yttria-stabilized zirconia (YSZ) balls and dry milled to obtain a solid ion conductor in powder form.

The dry milling was performed in an inert gas atmosphere for 24 hours, with repeated cycles of 15 minutes of milling at 400 rpm and 5 minutes or rest. The composition of the prepared solid ion conductor powder was Li_{1·4}Zr_{0·4}Ta_{0·6}OCl₄.

The solid ion conductor powder was molded into a pellet form and then pressed to produce a lithium ion conductor in pellet form.

### Example 2

A lithium ion conductor was prepared in the same manner as in Example 1, except that the zirconium content was changed from 0.4 to 0.6.

The composition of the manufactured solid ion conductor powder was Li_{1·6}Zr_{0·6}Ta_{0·4}OCl₄.

### Example 3

A lithium ion conductor was prepared in the same manner as in Example 1, except that the zirconium content was changed from 0.4 to 0.8.

The composition of the manufactured solid ion conductor powder was Li_{1·8}Zr_{0·8}Ta_{0·2}OCl₄.

### Comparative Example 1

A lithium ion conductor was prepared in the same manner as in Example 1, except that the zirconium content was changed from 0.4 to 0.2.

The composition of the prepared solid ion conductor powder was Li_{1·2}Zr_{0·2}Ta_{0·8}OCl₄.

### Comparative Example 2

A lithium ion conductor was prepared in the same manner as in Example 1, except that the zirconium content was changed from 0.4 to 1.0 by omitting the M1-containing precursor.

The composition of the manufactured solid ion conductor powder was Li₂ZrOCl₄.

### Reference Example 1

A lithium ion conductor was prepared in the same manner as in Comparative Example 2, except that the milling conditions were changed to include a crystalline phase.

The composition of the prepared solid ion conductor powder was Li₂ZrOCl₄, which was the same as in Comparative Example 2.

### Evaluation Example 1: XRD Analysis

The XRD spectra of the lithium-ion conductors prepared in Examples 1 to 3, Comparative Examples 1 to 2, and Reference Example 1 were measured, and the results are shown in FIGS. 1 and 2.

The XRD spectra were measured using X'pert pro (PANalytical) with Cu Kα radiation (1.54056 angstrom (Å)).

As shown in FIG. 1, the lithium ion conductors of Examples 1 to 3 exhibited a first peak at a diffraction angle of 16.0±1.0°2θ and a second peak at a diffraction angle of 32.0±1.0°2θ.

In the XRD spectra of each of the lithium ion conductors of Examples 1 to 3, the ratio (Ia/Ib) of the intensity of the first peak (Ia) to the intensity of the second peak (Ib) was found to be greater than 0 to 3.

Rietveld refinement analysis confirmed that the lithium ion conductors from Examples 1 to 3 contained a crystal phase belonging to the P-3m1 space group of the trigonal crystal system.

The lithium ion conductor of Comparative Example 1 did not exhibit a crystalline peak. Therefore, it was confirmed that the lithium ion conductor of Comparative Example 1 was an amorphous phase.

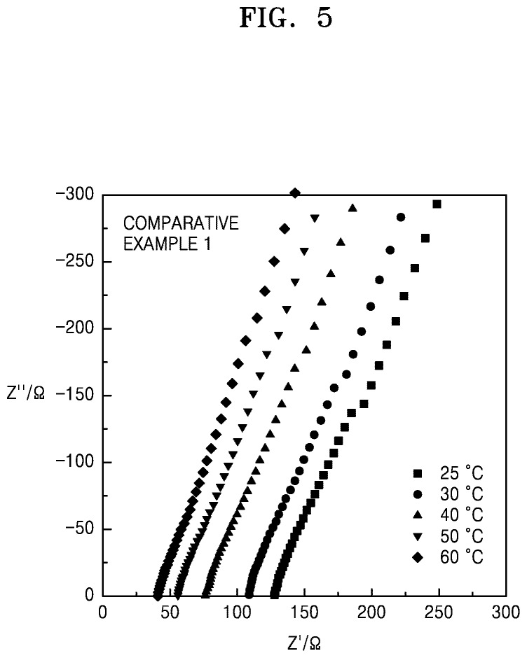

As shown in FIG. 5, the lithium ion conductors prepared in Comparative Example 2 and Reference Example 1 had the same composition (Li₂ZrOCl₄) but exhibited different XRD peaks.

The lithium ion conductor of Comparative Example 2 exhibited a first peak at a diffraction angle of 16.0±1.0°2θ and a second peak at a diffraction angle of 32.0±1.0°2θ.

Rietveld refinement confirmed that the lithium ion conductor from Comparative Example 2 contained a crystal phase belonging to the P-3m1 space group of the trigonal crystal system.

The lithium ion conductor of Reference Example 1 did not exhibit either the first peak at a diffraction angle of 16.0±1.0°2θ or the second peak at a diffraction angle of 32.0±1.0°2θ.

For the lithium ion conductor of Reference Example 1, it was confirmed through Reitveld refinement that it included a crystal phase belonging to the C2/m space group of the monoclinic crystal system.

It was confirmed that the lithium ion conductors manufactured in Comparative Example 2 and Reference Example 1 had the same composition (Li₂ZrOCl₄) but different crystal structures due to differences in preparation methods.

It was confirmed that crystalline compounds of the same composition have different crystal structures depending on the specific preparation method.

### Evaluation Example 2: Ionic Conductivity Measurement

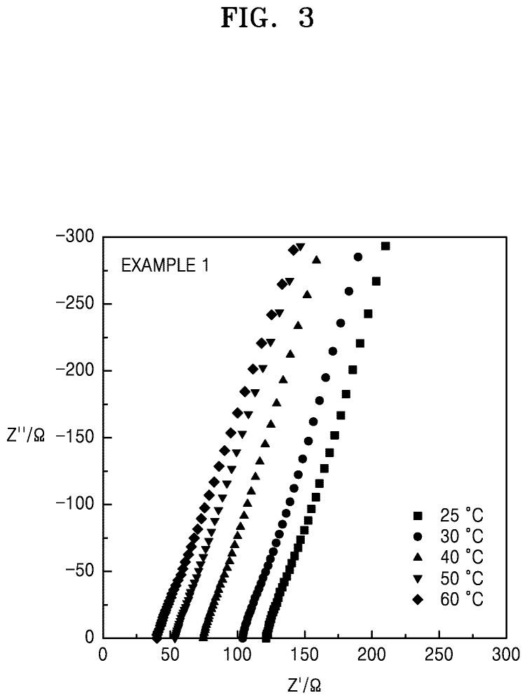

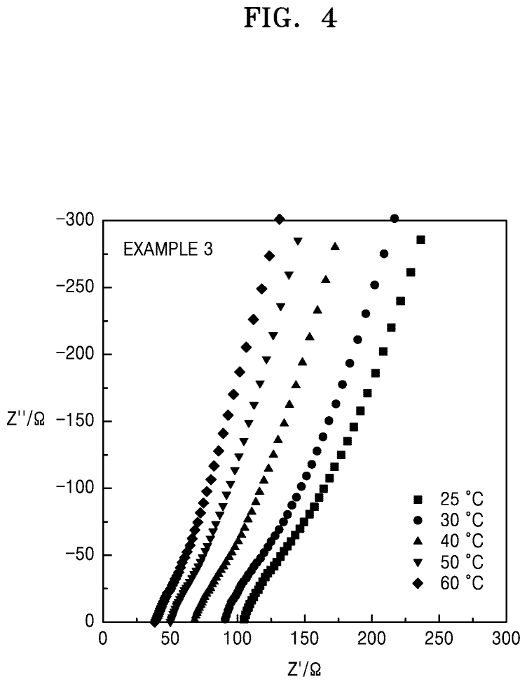

For the lithium ion conductor pellets prepared in Examples 1 to 3, Comparative Examples 1 to 2, and Reference Example 1, a gold (Au) electrode was deposited on both surfaces as a shielding electrode by sputtering, with a thickness of 20 nm. For the samples with shielding electrodes on both surfaces, impedance measurements were performed using an impedance analyzer (Solartron 1400A/1455A impedance analyzer) with the two-probe method. The frequency range was 7 megahertz (MHz) to 1 hertz (Hz), and the amplitude voltage was 10 millivolts (mV). Measurements were made at 1 atm and 25° C. in air atmosphere. From the Nyquist plot obtained from the impedance measurements, the resistance values were determined. The ionic conductivity was calculated after correcting for the electrode area and pellet thickness, and the results are shown in Table 1 and FIGS. 3 to 5.

TABLE 1

| | Ionic conductivity [mS/cm] |
|---|---|
| Example 1 | 0.52 |
| Example 3 | 0.38 |
| Comparative Example 2 | 0.24 |

As shown in Table 1, the lithium ion conductors from Examples 1 and 3 exhibited higher ionic conductivity compared to the lithium ion conductor from Comparative Example 2.

During the ionic conductivity measurement, there was minimal change in the ionic conductivity of the lithium ion conductor over time.

Thus, it was confirmed that the lithium ion conductors prepared in Examples 1 and 3 are electrochemically stable and stable in ambient conditions.

### Evaluation Example 3: Activation Energy Measurement

The activation energy of the lithium-ion conductors prepared in Examples 1 to 3, Comparative Example 1, and Reference Examples 1 to 2 was measured using the same method as in Evaluation Example 2.

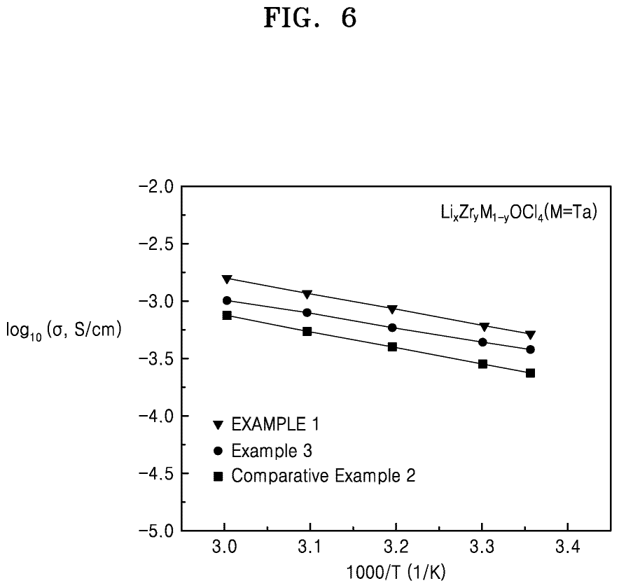

The ionic conductivity was measured at different temperatures: 25° C., 30° C., 40° C., 50° C., and 60° C. An Arrhenius plot was constructed based on the ionic conductivity measurements at different temperatures, and the activation energy was calculated from the slope of the plot. The results are presented in Table 2 and FIG. 6.

TABLE 2

| | Activation energy [meV] |
|---|---|
| Example 1 | 274 |
| Example 3 | 242 |
| Comparative Example 2 | 278 |

As shown in Table 2, the lithium ion conductors from Examples 1 and 3 exhibited lower activation energy compared to the lithium-ion conductor from Comparative Example 2.

Although the disclosure has been described in terms of an exemplary embodiment, it is not limited thereto, and it is possible to implement the disclosure by making various modifications within the scope of the claims, the detailed description of the invention, and the attached drawings, and such modifications are also within the scope of the disclosure.

According to an aspect, a novel lithium ion conductor has improved ionic conductivity.

According to another aspect, a lithium battery including a novel lithium ion conductor is provided.

According to another aspect, a method of preparing a novel lithium ion conductor is provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A lithium ion conductor comprising a first compound represented by Formula 1,
wherein the first compound comprises a crystalline phase belonging to the P-3m1 space group of a trigonal crystal system: 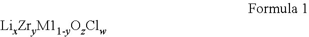
wherein in Formula 1,
M1 comprises one or more elements belonging to groups 3 to 15 of the periodic table, and
1≤x≤3, 0.2<y<1, 0.5≤z≤1.5, 3.5≤w≤4.5 and 4.5≤z+w≤5.5.

2. The lithium ion conductor of claim 1,
wherein M1 comprises Ta, Nb, Hf, Sn, Al, In, Sb, Sc, Y, La, Ce, Pr, Nd, Pm, Sm, Eu, Gd, Tb, Dy, Ho, Er, Tm, Yb, Lu or a combination thereof.

3. The lithium ion conductor of claim 1,
wherein the first compound is represented by Formula 2: 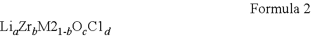
wherein in Formula 2,
M2 comprises Ta, Nb, Hf, Sn, Sc, Y, Al, In, Sb or a combination thereof, and
1≤a≤3, 0.2<b<1, 0.8≤c≤1.2, 3.7≤d≤4.3 and 4.5≤c+d≤5.5.

4. The lithium ion conductor of claim 1,
wherein the first compound is represented by Formula 3: 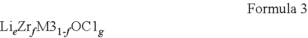
wherein in Formula 3,
M3 comprises Ta, Nb, Hf, Sn, Sc, Y, Al, In, Sb or a combination thereof, and
1≤e≤3, 0.2<f<1 and 3.7≤g≤4.3.

5. The lithium ion conductor of claim 1,
wherein the first compound is represented by one of Formulae 4A to 4I:

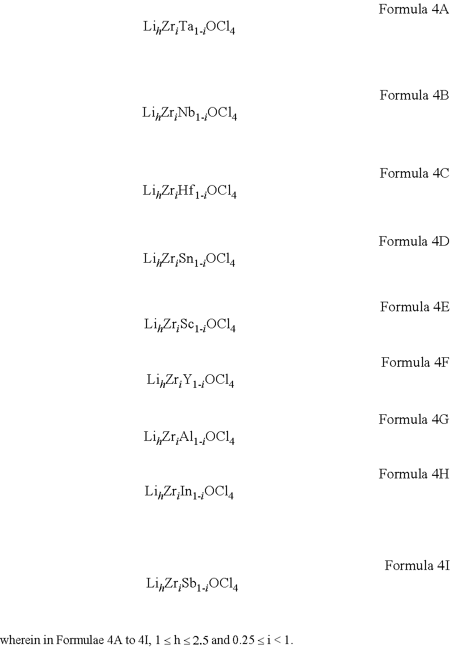

6. The lithium ion conductor of claim 1,
wherein the X-ray diffraction spectrum of the lithium ion conductor exhibits a first peak at a diffraction angle of 16.0±1.0°2θ and a second peak at a diffraction angle of 32.0±1.0°2θ.

7. The lithium ion conductor of claim 6,
wherein the ratio of the intensity of the first peak to the intensity of the second peak is 3 or less.

8. The lithium ion conductor of claim 1,
wherein the lithium ion conductor has an ionic conductivity of 0.1 milliSiemen per centimeter or more at 25° C. and 1 standard atmosphere.

9. The lithium ion conductor of claim 1,
wherein the lithium ion conductor has an activation energy of 300 millielectronvolts or less at 25° C. and 1 standard atmosphere.

10. The lithium ion conductor of claim 1,
wherein the first compound further comprises a crystalline phase belonging to the Pnma space group of the orthorhombic crystal system.

11. The lithium ion conductor of claim 1,
wherein the first compound further comprises a crystalline phase belonging to the P63mc space group of the hexagonal crystal system.

12. The lithium ion conductor of claim 1,
wherein the lithium ion conductor further comprises a second compound, and the second compound comprises an amorphous phase.

13. The lithium ion conductor of claim 12,
wherein the content of the second compound is 3 weight percent or less based on the total weight of the first compound and the second compound.

14. The lithium ion conductor of claim 12,
wherein the second compound comprises lithium, zirconium, a first metal belonging to groups 3 to 15 of the periodic table, oxygen, and chlorine, and
wherein the second compound comprises about 1 mole to about 3 mole of lithium, more than about 0 mole to less than about 0.2 mole of zirconium, more than about 0.2 mole to less than about 1 mole of the first metal, about 0.5 mole to about 1.5 mole of oxygen, and about 3.5 mole to about 4.5 mole of chlorine, based on 1 mole of the second compound.

15. The lithium ion conductor of claim 1,
wherein the first compound comprises about 1.0 mole to less than about 1.7 mole of lithium based on 1 mole of the first compound, and
wherein the molar ratio of oxygen to dopant M1 in the first compound is 1 or more.

16. The lithium ion conductor of claim 1,
wherein the lithium ion conductor is free of a crystalline phase belonging to a monoclinic crystal system, and free of a crystalline phase belonging to a cubic crystal system.

17. The lithium ion conductor of claim 16,
wherein the X-ray diffraction spectrum of the lithium ion conductor is free of the third peak at a diffraction angle of 21.5±1.5°2θ, the fourth peak at a diffraction angle of 30.0±0.5°2θ, and the fifth peak at a diffraction angle of 35.0±0.5°2θ.

18. A lithium battery comprising:
a cathode; an anode; and
a solid electrolyte layer disposed between the cathode and the anode, and
wherein at least one of the cathode, the anode and the solid electrolyte layer comprises the lithium ion conductor of claim 1.

19. The lithium battery of claim 18,
wherein the cathode comprises one or more cathode active material particles and
the lithium ion conductor which is disposed on or between the cathode active material particles.

20. A method of preparing a lithium ion conductor comprising:
mixing a lithium precursor, a zirconium precursor, a dopant M1 precursor, and a chlorine precursor to prepare a mixture; and
mechanically milling the mixture to prepare the lithium ion conductor,
wherein the lithium ion conductor comprises a first compound represented by Formula 1, and
the first compound comprises a crystalline phase belonging to the P-3m1 space group of a trigonal crystal system: 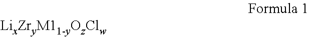
wherein in Formula 1,
M1 comprises one or more elements belonging to groups 3 to 15 of the periodic table, and
1≤x≤3, 0.2<y<1, 0.5≤z≤1.5, 3.5≤w≤4.5 and 4.5≤z+w≤5.5.
